(19) United States
(12) Patent Application Publication
(10) Pub. No.: US 2026/0066264 A1
(43) Pub. Date: Mar. 5, 2026

(54) METHOD FOR MANUFACTURING MEMBRANE ELECTRODE ASSEMBLY AND APPARATUS FOR MANUFACTURING MEMBRANE ELECTRODE ASSEMBLY

(71) Applicant: HONDA MOTOR CO., LTD., TOKYO (JP)

(72) Inventors: Kento KUSATSUGU, WAKO-SHI (JP); Wataru KASHI, WAKO-SHI (JP); Yohei KATAOKA, WAKO-SHI (JP); Shinsuke CHOKYU, WAKO-SHI (JP)

(21) Appl. No.: 19/307,284

(22) Filed: Aug. 22, 2025

(30) Foreign Application Priority Data
Aug. 28, 2024 (JP) 2024-146288

(51) Int. Cl. H01M 4/04; H01M 4/02; H01M 10/04

(52) U.S. Cl. CPC H01M 4/0452; H01M 4/0407; H01M 4/0471; H01M 10/0409; H01M 2004/021; H01M 2300/0028; H01M 2300/0082

(57) ABSTRACT

A method for manufacturing a membrane electrode assembly includes an applying step of applying a catalyst ink to a first surface of a polymer electrolyte membrane, and a drying step of drying the applied catalyst ink. The applying step is performed in a state where a second surface of the polymer electrolyte membrane opposite to the first surface is in contact with a swelling solvent that swells the polymer electrolyte membrane.

### CROSS-REFERENCE TO RELATED APPLICATIONS

This application is based upon and claims the benefit of priority from Japanese Patent Application No. 2024-146288 filed on Aug. 28, 2024, the contents of which are incorporated herein by reference.

### BACKGROUND OF THE INVENTION

### Field of the Invention

The present disclosure relates to a method for manufacturing a membrane electrode assembly and an apparatus for manufacturing a membrane electrode assembly.

### Description of the Related Art

A membrane electrode assembly, which includes a polymer electrolyte membrane and a catalyst layer (also referred to as an electrode layer) formed on a surface of the polymer electrolyte membrane, is used in an electrochemical cell such as a fuel cell, a water electrolysis device, or an electrochemical hydrogen pump.

For example, JP 2014-067539 A discloses a method for producing a membrane electrode assembly by applying a catalyst ink to the surface of a polymer electrolyte membrane.

### SUMMARY OF THE INVENTION

There is a demand for further improvements in the performance of the membrane electrode assembly used in the electrochemical cell.

It is an object of the present disclosure to solve the above problems.

A first aspect of the present disclosure is a method for manufacturing a membrane electrode assembly, the method including: an applying step of applying a catalyst ink to a first surface of a polymer electrolyte membrane; and a drying step of drying the catalyst ink that has been applied, wherein the applying step is performed in a state where a second surface of the polymer electrolyte membrane opposite to the first surface is in contact with a swelling solvent that swells the polymer electrolyte membrane.

A second aspect of the present disclosure is an apparatus for manufacturing a membrane electrode assembly, the apparatus including: a solvent storage unit configured to store a swelling solvent; a frame-shaped jig provided on the solvent storage unit, the frame-shaped jig being configured to bring a polymer electrolyte membrane into contact with the swelling solvent while supporting a peripheral edge portion of the polymer electrolyte membrane; an applying device disposed above the polymer electrolyte membrane and configured to apply a catalyst ink to the polymer electrolyte membrane; and a drying device configured to heat and dry the catalyst ink applied to the polymer electrolyte membrane, wherein the drying device is disposed rearward of the applying device in a direction of relative movement of the applying device with respect to the polymer electrolyte membrane.

According to the present disclosure, deformation due to swelling of the polymer electrolyte membrane is suppressed, and therefore, the performance of the membrane electrode assembly is further improved.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a cross-sectional view of a membrane electrode assembly;

FIG. 2 is an explanatory view of a manufacturing apparatus for a membrane electrode assembly according to a first embodiment;

FIG. 3 is an explanatory view showing the manufacturing apparatus for the membrane electrode assembly of FIG. 2 as viewed from above;

FIG. 4 is a flowchart showing a method for manufacturing a membrane electrode assembly according to the first embodiment;

FIG. 5 is an explanatory view of a manufacturing apparatus for a membrane electrode assembly according to a second embodiment; and

FIG. 6 is a photograph showing wrinkles occurring when a membrane electrode assembly according to a comparative example is swollen.

### DETAILED DESCRIPTION OF THE INVENTION

### First Embodiment

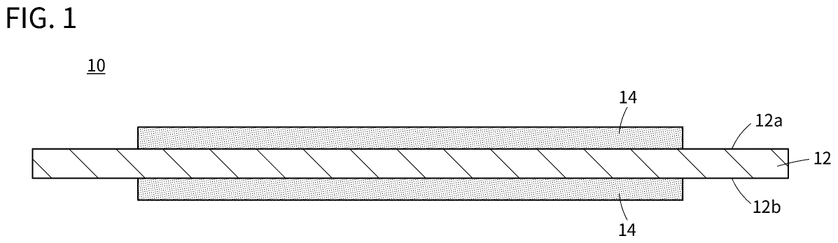

As shown in FIG. 1, a membrane electrode assembly 10 manufactured by a method described in the present embodiment includes a polymer electrolyte membrane 12 and a catalyst layer 14 laminated on the polymer electrolyte membrane 12. The catalyst layer 14 is formed on each of a first surface 12a and a second surface 12b, which are surfaces of the polymer electrolyte membrane 12. The polymer electrolyte membrane 12 is, for example, a cation exchange membrane having hydrogen ion conductivity or an anion exchange membrane having hydroxide ion conductivity. The thickness of the polymer electrolyte membrane 12 is appropriately selected within a range of 5 μm to 300 μm depending on its application.

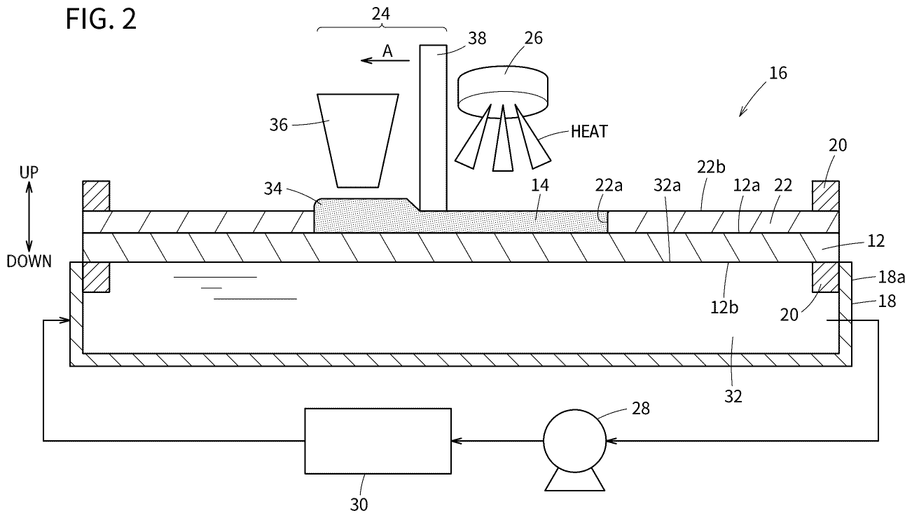

The catalyst layer 14 is also referred to as an electrode layer. The catalyst layer 14 is composed of a mixture containing an ionomer and support particles such as carbon. The support particles support fine particles of a catalyst made of, for example, platinum (Pt), palladium (Pd), rhodium (Rh), iridium (Ir), ruthenium (Ru), or an alloy thereof. The ionomer is composed of an ion-conductive polymer that serves as a path through which ions pass. The catalyst layer 14 is a porous body, and has open pores formed between the support particles and the ion conductive polymer. In the present embodiment, the catalyst layer 14 (FIG. 2) having a doughnut shape, which is used in a water electrolysis device, an electrochemical hydrogen pump, or the like, will be described as an example, but the shape of the catalyst layer 14 is not limited thereto. The shape of the catalyst layer 14 may be a rectangular shape which is often used in a fuel cell or the like.

The membrane electrode assembly 10 is sandwiched between a pair of gas diffusion layers (not shown) in the thickness direction, and further sandwiched, over the gas diffusion layers, between a pair of separators in the thickness direction, thereby constituting one electrochemical cell.

For example, some electrochemical cells such as the electrochemical hydrogen pumps and the water electrolysis devices are used in a higher water content state, as compared to the fuel cells. Therefore, deformation due to swelling of the polymer electrolyte membrane 12 tends to occur during use of the electrochemical cell. In order to prevent such a problem, the inventors of the present application have studied a step of assembling an electrochemical cell after immersing the membrane electrode assembly 10 in water to swell the membrane electrode assembly 10 in advance before assembling the electrochemical cell.

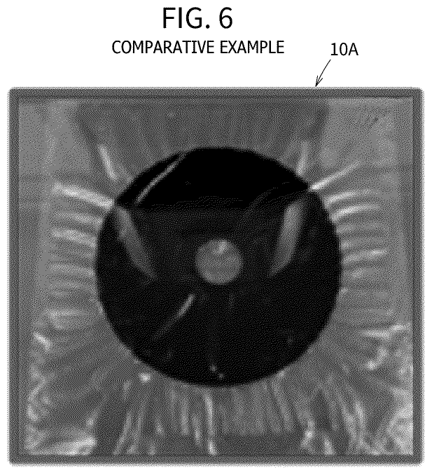

However, as shown in FIG. 6, it has been found that when a membrane electrode assembly 10A (comparative example) manufactured by the conventional manufacturing method is immersed in water, wrinkles occur due to the difference in expansion coefficient between the polymer electrolyte membrane and the catalyst layer.

In the present embodiment, a membrane electrode assembly manufacturing apparatus (an apparatus for manufacturing a membrane electrode assembly) 16 described below is used for manufacturing the membrane electrode assembly 10.

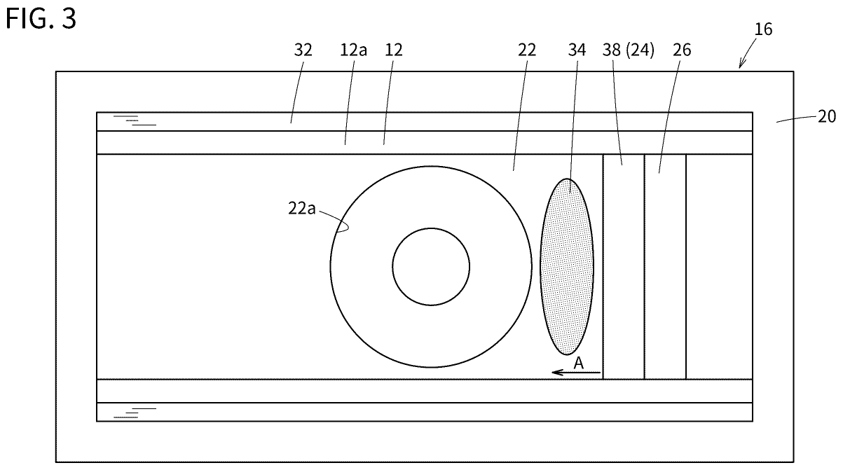

As shown in FIGS. 2 and 3, the membrane electrode assembly manufacturing apparatus 16 of the present embodiment includes a solvent storage unit 18, a frame-shaped jig 20, a metal mask 22, an applying device 24, a drying device 26, a pump 28, and a solvent heating device 30. The solvent storage unit 18 is a container having a predetermined depth. The peripheral portion of the solvent storage unit is surrounded by a sidewall 18a. The solvent storage unit 18 is formed in a rectangular shape when viewed from above. The solvent storage unit 18 stores a swelling solvent 32 in a container surrounded by the sidewall 18a. The upper portion of the solvent storage unit 18 is open. The liquid surface 32a of the swelling solvent 32 is exposed at the upper portion of the solvent storage unit 18.

The swelling solvent 32 is a solvent that infiltrates into the polymer electrolyte membrane 12 to swell the polymer electrolyte membrane 12. As the swelling solvent 32, for example, water, alcohols, or a mixture thereof can be used. The swelling solvent 32 preferably has a boiling point equal to or higher than the boiling point (initial boiling point) of the solvent used in a catalyst ink 34 described later.

The pump 28 causes the swelling solvent 32 to flow inside the solvent storage unit 18. The pump 28 circulates the swelling solvent 32 to thereby suppress the occurrence of a local high-temperature portion of the swelling solvent 32 due to heating by the drying device 26. In the illustrated example, the pump 28 is disposed outside the solvent storage unit 18, but the present invention is not limited thereto. The pump 28 may be disposed inside the solvent storage unit 18.

The solvent heating device 30 heats the swelling solvent 32 inside the solvent storage unit 18 to a predetermined temperature higher than room temperature. The solvent heating device 30 heats the swelling solvent 32 to a temperature higher than the boiling point (initial boiling point) of the catalyst ink 34 and lower than the boiling point of the swelling solvent 32, for example.

The frame-shaped jig 20 is disposed on the solvent storage unit 18. The frame-shaped jig 20 is formed in a rectangular shape when viewed from above. The frame-shaped jig 20 is vertically dividable, and sandwiches, from above and below, the peripheral edge of the polymer electrolyte membrane 12 and the peripheral edge of the metal mask 22, thereby holding them. The frame-shaped jig 20 supports the polymer electrolyte membrane 12 with the first surface 12a of the polymer electrolyte membrane 12 facing upward and the second surface 12b thereof facing downward, in a state where the polymer electrolyte membrane 12 is not wrinkled. The second surface 12b of the polymer electrolyte membrane 12 is exposed within the frame-shaped jig 20. When the frame-shaped jig 20 is attached to the solvent storage unit 18, the second surface 12b of the polymer electrolyte membrane 12 comes into contact with the liquid surface 32a of the swelling solvent 32.

The shape of the frame-shaped jig 20 as viewed from above is not limited to a rectangular shape. The frame-shaped jig 20 may be configured to hold only two opposite sides of the polymer electrolyte membrane 12. The frame-shaped jig 20 may have an annular shape when viewed from above.

The metal mask 22 is disposed so as to cover the first surface 12a of the polymer electrolyte membrane 12. The metal mask 22 is made of a metal sheet having the same thickness as the catalyst layer 14. The metal mask 22, together with the polymer electrolyte membrane 12, is supported by the frame-shaped jig 20. The metal mask 22 has an opening 22a formed in a predetermined shape. The first surface 12a of the polymer electrolyte membrane 12 is exposed through the opening 22a of the metal mask 22. The metal mask 22 enables the formation of the catalyst layer 14 having a predetermined shape through the opening 22a. Further, since the metal mask 22 is made of a material having a higher rigidity than the polymer electrolyte membrane 12, the waving of the liquid surface 32a of the swelling solvent 32 is prevented, and the deformation of the polymer electrolyte membrane 12 is prevented.

When the thickness of the polymer electrolyte membrane 12 is as large as about 100 μm, for example, the polymer electrolyte membrane 12 itself exerts an effect of preventing the swelling solvent 32 from waving, and therefore, deformation due to the waving of the swelling solvent 32 can be suppressed without the need of using the metal mask 22. Therefore, the metal mask 22 may be omitted depending on the thickness of the polymer electrolyte membrane 12. In this case, a flexible mask made of a resin sheet or the like may be used. The polymer electrolyte membrane 12 may be attached to the frame-shaped jig 20 after being attached to the metal mask 22.

The applying device 24 includes an ink supply unit 36 and a blade 38. The ink supply unit 36 is disposed above the metal mask 22 and the polymer electrolyte membrane 12. The ink supply unit 36 discharges the catalyst ink 34 from above the polymer electrolyte membrane 12 toward the first surface 12a.

The catalyst ink 34 is a paste-like liquid agent containing support particles, an ionomer, and an ink solvent. The ink solvent may be constituted by, for example, an alcohol such as ethanol, methanol, or propanol, or a mixed solvent of such an alcohol and water. The ink solvent is selected from solvents having a volatility comparable to or higher than that of the swelling solvent 32 in order to enable rapid drying. That is, the ink solvent may have the same composition as the swelling solvent 32. More preferably, the ink solvent is selected from solvents having a boiling point (initial boiling point) lower than the boiling point of the swelling solvent 32.

The blade 38 is a plate-shaped member that slides while abutting on the upper surface 22b of the metal mask 22. The blade 38 moves while sliding in a predetermined direction along the upper surface 22b of the metal mask 22, thereby spreading the catalyst ink 34. The catalyst ink 34 spread by the blade 38 enters the opening 22a of the metal mask 22 and is applied to the first surface 12a of the polymer electrolyte membrane 12 exposed through the opening 22a. The layer of the catalyst ink 34 having substantially the same thickness as the metal mask 22 is formed by the blade 38.

The drying device 26 is disposed above the polymer electrolyte membrane 12 and is disposed rearward of the blade 38 (the applying device 24) in the direction of relative movement of the blade 38 relative to the polymer electrolyte membrane 12. The drying device 26 applies heat ray or blows hot air to the applied catalyst ink 34 to thereby dry the catalyst ink 34. The drying here means that at least part of the ink solvent contained in the catalyst ink 34 is volatilized to thereby bring the catalyst ink 34 to a solid state having substantially no fluidity, and does not necessarily mean that all the ink solvent is volatilized and removed. When the thickness of the polymer electrolyte membrane 12 is small, the polymer electrolyte membrane 12 is likely to be deformed due to the waving of the swelling solvent 32. Therefore, in order to prevent the swelling solvent 32 from waving, it is preferable that the drying device 26 does not blow out air but applies only heat ray to the catalyst ink 34.

The membrane electrode assembly manufacturing apparatus 16 according to the present embodiment is configured as described above. Hereinafter, a method for manufacturing the membrane electrode assembly 10 will be described.

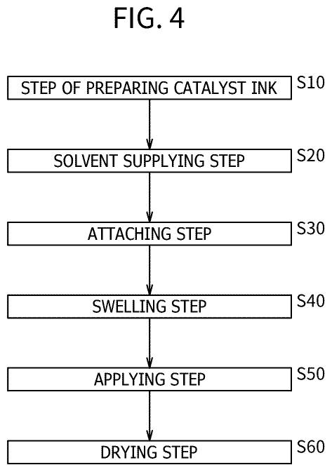

As shown in FIG. 4, first, a step of preparing the catalyst ink 34 (step S10) is performed. The catalyst ink 34 is prepared by mixing support particles, ionomer powder, and an ink solvent. As the ink solvent, for example, a solvent containing alcohol as a main component and a small amount of water or the like is used. The prepared catalyst ink 34 is filled into the ink supply unit 36.

Next, a solvent supplying step (step S20) of supplying a predetermined swelling solvent 32 to the solvent storage unit 18 is performed. The swelling solvent 32 is, for example, water. The swelling solvent 32 is circulated by the pump 28 and heated to a predetermined temperature by the solvent heating device 30. By causing the swelling solvent 32 to flow, it is possible to prevent the temperature of the polymer electrolyte membrane 12 from rising in a drying step described later, and it is possible to make the state of the interface between the polymer electrolyte membrane 12 and the catalyst ink 34 uniform. The state of the interface between the polymer electrolyte membrane 12 and the catalyst ink 34 affects the porous structure of the catalyst layer 14 after drying. Thus, keeping the swelling solvent 32 in a flowing state contributes to making the catalyst layer 14 uniform.

Next, an attaching step (step S30) of attaching the polymer electrolyte membrane 12 to the frame-shaped jig 20 is performed. In the case of using the metal mask 22, a metal mask disposing step of disposing the metal mask 22 on the first surface 12a of the polymer electrolyte membrane 12 is performed in the attaching step. The metal mask 22, together with the polymer electrolyte membrane 12, is attached to the frame-shaped jig 20.

Next, a swelling step (step S40) is performed in which the second surface 12b of the polymer electrolyte membrane 12 is brought into contact with the liquid surface 32a of the swelling solvent 32 (liquid). The swelling step is performed by disposing the frame-shaped jig 20 on the upper portion of the solvent storage unit 18. In the swelling step, the second surface 12b of the polymer electrolyte membrane 12 comes into contact with the swelling solvent 32, and the swelling solvent 32 infiltrates into the polymer electrolyte membrane 12, whereby the polymer electrolyte membrane 12 is swollen. At this time, the first surface 12a is maintained in a dry state without the presence of droplets of the swelling solvent 32.

Next, an applying step (step S50) of applying the catalyst ink 34 to the first surface 12a of the polymer electrolyte membrane 12 is performed. The applying step is performed by discharging the catalyst ink 34 from the ink supply unit 36 to the upper surface 22b of the metal mask 22 and then moving the blade 38 in the direction of arrow A in FIG. 2. The catalyst ink 34 is applied to the polymer electrolyte membrane 12 exposed through the opening 22a of the metal mask 22, by the movement of the blade 38. The applying step is performed in a state where the second surface 12b of the polymer electrolyte membrane 12 is in contact with the swelling solvent 32. According to the present embodiment, the difference in expansion coefficient between the catalyst layer 14 and the polymer electrolyte membrane 12 is smaller than in the case where the catalyst ink 34 is applied in a state where swelling of the polymer electrolyte membrane 12 is suppressed, and therefore the occurrence of wrinkles on the polymer electrolyte membrane 12 and the occurrence of thin portions in the catalyst layer 14 can be suppressed.

Thereafter, a drying step (step S60) of drying the catalyst ink 34 is performed. The drying step is performed by applying heat ray (and blowing hot air as necessary) from the drying device 26 of FIG. 2 to the catalyst ink 34 to heat the catalyst ink 34. The drying by the drying device 26 is performed while the drying device 26 is moved so as to follow the blade 38 of the applying device 24. This eliminates the need for separately providing a dryer and a conveying device associated with the dryer, and thus enables simplification and space saving of the manufacturing apparatus 16. In addition, deformation of the polymer electrolyte membrane 12 due to factors such as vibration during conveyance and handling is suppressed, and thus the quality of the membrane electrode assembly 10 is improved.

The drying step is performed in a state where the second surface 12b of the polymer electrolyte membrane 12 is in contact with the swelling solvent 32. Therefore, even when part of the swelling solvent 32 contained in the polymer electrolyte membrane 12 is volatilized in the drying step, the swelling solvent 32 is quickly supplied from the second surface 12b side. Therefore, the catalyst ink 34 can be dried while the polymer electrolyte membrane 12 is swollen, and the shrinkage of the polymer electrolyte membrane 12 in the drying step is suppressed.

Thus, the catalyst layer 14 is formed on the first surface 12a of the polymer electrolyte membrane 12. Thereafter, another metal mask 22 may be disposed on the first surface 12a of the polymer electrolyte membrane 12 as necessary, and the catalyst ink 34 for the second and subsequent layers may be applied and dried.

In addition, the catalyst layer 14 may be formed on the second surface 12b of the polymer electrolyte membrane 12 based on the steps (steps S10, S20, S30, S40, S50, and S60) described with reference to FIG. 4. In this case, the application of the catalyst ink 34 to the second surface 12b of the polymer electrolyte membrane 12 and the drying thereof are performed in a state where the first surface 12a with the catalyst layer 14 formed thereon is in contact with the swelling solvent 32.

The step of forming the catalyst layer 14 on the second surface 12b of the polymer electrolyte membrane 12 may be performed by a method of transferring (attaching) the catalyst layer 14 formed in a predetermined shape in advance, to the second surface 12b of the polymer electrolyte membrane 12.

The membrane electrode assembly 10 having the polymer electrolyte membrane 12 and the catalyst layers 14 is completed by performing the above steps. The membrane electrode assembly 10 thus completed may be supplied to an assembly process of an electrochemical cell while the polymer electrolyte membrane 12 is swollen.

### Second Embodiment

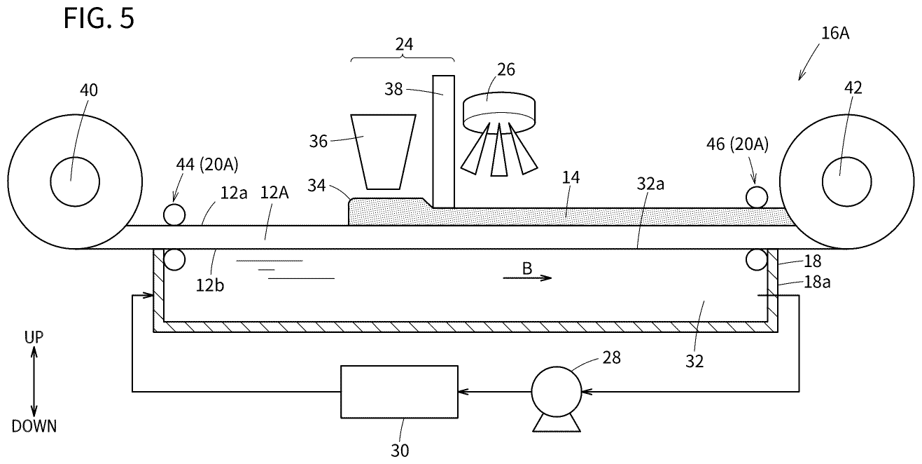

As shown in FIG. 5, the membrane electrode assembly manufacturing apparatus 16A of the present embodiment continuously applies and dries the catalyst ink 34 to a polymer electrolyte membrane 12A that is originally wound in a roll shape. In the configuration of the membrane electrode assembly manufacturing apparatus 16A of the present embodiment, the same components as those of the membrane electrode assembly manufacturing apparatus 16 described with reference to FIGS. 2 and 3 are denoted by the same reference numerals, and the detailed description thereof is omitted.

As shown in FIG. 5, the membrane electrode assembly manufacturing apparatus 16A includes a roll supplying unit 40, a roll winding unit 42, and a second frame-shaped jig 20A, in addition to the solvent storage unit 18, the applying device 24, the drying device 26, the pump 28, and the solvent heating device 30. The configurations of the solvent storage unit 18, the applying device 24, the drying device 26, the pump 28, and the solvent heating device 30 are the same as the corresponding configurations of the membrane electrode assembly manufacturing apparatus 16 described with reference to FIGS. 2 and 3.

The roll supplying unit 40 unwinds and supplies the polymer electrolyte membrane 12A wound in a roll shape, to the solvent storage unit 18. The roll winding unit 42 winds up the polymer electrolyte membrane 12A with the catalyst layer 14 formed thereon, into a roll shape. The polymer electrolyte membrane 12A supplied from the roll supplying unit 40 moves in the direction of arrow B in the solvent storage unit 18 and is wound by the roll winding unit 42.

The second frame-shaped jig 20A includes a first roller unit 44 and a second roller unit 46. The first roller unit 44 is attached to one end of the solvent storage unit 18, and the second roller unit 46 is attached to the other end of the solvent storage unit 18. The polymer electrolyte membrane 12A supplied from the roll supplying unit 40 enters the solvent storage unit 18 via the first roller unit 44, and is discharged from the solvent storage unit 18 via the second roller unit 46. The first roller unit 44 and the second roller unit 46 bring the second surface 12b of the polymer electrolyte membrane 12A into contact with the swelling solvent 32 while maintaining the polymer electrolyte membrane 12A in a state of being stretched without wrinkles.

The applying device 24 applies the catalyst ink 34 to the first surface 12a of the polymer electrolyte membrane 12A while the polymer electrolyte membrane 12A is continuously moving. The drying device 26 is disposed rearward of the applying device 24 in the direction of relative movement of the applying device 24 relative to the polymer electrolyte membrane 12A, and dries the applied catalyst ink 34.

The catalyst layer 14 (electrode layer) is formed on the first surface 12a of the polymer electrolyte membrane 12A by drying the catalyst ink 34. The polymer electrolyte membrane 12A with the catalyst layer 14 formed thereon passes through the second roller unit 46 and is wound by the roll winding unit 42.

In the present embodiment, the application of the catalyst ink 34 and the drying of the catalyst ink 34 are performed in a state where the second surface 12b of the polymer electrolyte membrane 12A is in contact with the swelling solvent 32.

The application and drying of the catalyst ink 34 on the second surface 12b can also be performed in the same manner as described above while the first surface 12a with the catalyst layer 14 formed thereon is brought into contact with the swelling solvent 32. The catalyst layer 14 may be formed on the second surface 12b by transferring (attaching) a separately-formed catalyst.

The present embodiment also achieves the same effects as those of the first embodiment.

The following Supplementary Notes are further disclosed in relation to the above embodiments.

### (Supplementary Note 1)

The method for manufacturing the membrane electrode assembly (10) of the present disclosure includes the applying step (step S50) of applying the catalyst ink (34) to the first surface (12a) of the polymer electrolyte membrane (12, 12A), and the drying step (step S60) of drying the catalyst ink that has been applied, wherein the applying step is performed in a state where the second surface (12b) of the polymer electrolyte membrane opposite to the first surface is in contact with the swelling solvent (32) that swells the polymer electrolyte membrane.

According to the above method, the catalyst ink can be applied while the polymer electrolyte membrane is kept in a swollen state. Thus, the occurrence of wrinkles in the membrane electrode assembly and the occurrence of thin portions in the catalyst layer can be suppressed when assembling the electrochemical cell.

### (Supplementary Note 2)

In the method for manufacturing the membrane electrode assembly according to Supplementary Note 1, the boiling point of the swelling solvent may be higher than the boiling point of the ink solvent contained in the catalyst ink. According to this method, the catalyst ink can be quickly dried.

### (Supplementary Note 3)

In the method for manufacturing the membrane electrode assembly according to Supplementary Note 1, the swelling solvent may be heated water. According to this method, drying of the catalyst ink can be promoted.

### (Supplementary Note 4)

In the method for manufacturing the membrane electrode assembly according to Supplementary Note 1, the swelling solvent may be kept in a flowing state. According to this method, the temperature of the polymer electrolyte membrane can be kept uniform, and the interface state between the electrode ink and the polymer electrolyte membrane can be kept uniform, whereby a homogeneous catalyst layer can be formed.

### (Supplementary Note 5)

The method for manufacturing the membrane electrode assembly according to Supplementary Note 1 may further include, prior to the applying step, the metal mask disposing step of disposing the metal mask (22) on the first surface of the polymer electrolyte membrane, and in the applying step, the catalyst ink may be applied to the polymer electrolyte membrane through the opening (22a) of the metal mask. According to this method, the mask can prevent the surface of the swelling solvent from waving, and thus it is possible to suppress deformation of the polymer electrolyte membrane.

### (Supplementary Note 6)

In the method for manufacturing the membrane electrode assembly according to Supplementary Note 1, in the drying step, the catalyst ink may be dried by heating the catalyst ink in a state where the second surface of the polymer electrolyte membrane is in contact with the swelling solvent. According to this method, the shrinkage of the polymer electrolyte membrane in the drying step can be prevented.

### (Supplementary Note 7)

In the method for manufacturing the membrane electrode assembly according to Supplementary Notes 1 to 6, the applying step may be performed using the manufacturing apparatus (16, 16A), the manufacturing apparatus including: the solvent storage unit (18) configured to store the swelling solvent; the frame-shaped jig (20) provided on the solvent storage unit, the frame-shaped jig being configured to bring the second surface of the polymer electrolyte membrane into contact with the swelling solvent while supporting the peripheral edge portion of the polymer electrolyte membrane; and the applying device (24) disposed above the polymer electrolyte membrane and configured to apply the catalyst ink to the polymer electrolyte membrane, and the method may further include: prior to the applying step, the solvent supplying step (step S20) of supplying the swelling solvent to the solvent storage unit; and the swelling step (step S40) of supporting the polymer electrolyte membrane on the frame-shaped jig and bringing the second surface of the polymer electrolyte membrane into contact with the swelling solvent. According to this method, the shape of the polymer electrolyte membrane can be stabilized by using the frame-shaped jig, and therefore, a membrane electrode assembly having less unevenness can be formed.

### (Supplementary Note 8)

In the method for manufacturing the membrane electrode assembly according to Supplementary Note 7, the manufacturing apparatus may further include the drying device (26) configured to heat and dry the catalyst ink applied to the first surface of the polymer electrolyte membrane, the drying device may be disposed rearward of the applying device in the direction of relative movement of the applying device relative to the polymer electrolyte membrane, and the drying step may be performed by relatively moving the drying device relative to the polymer electrolyte membrane so as to follow the applying device.

According to this method, the drying is performed immediately after the applying step. Thus, the equipment or facility can be simplified and variation in the quality of the membrane electrode assembly can be suppressed.

### (Supplementary Note 9)

The present disclosure is characterized by the apparatus (16, 16A) for manufacturing the membrane electrode assembly, the apparatus including: the solvent storage unit (18) configured to store the swelling solvent (32); the frame-shaped jig (20) provided on the solvent storage unit, the frame-shaped jig being configured to bring the polymer electrolyte membrane (12, 12A) into contact with the swelling solvent while supporting the peripheral edge portion of the polymer electrolyte membrane; the applying device (24) disposed above the polymer electrolyte membrane and configured to apply the catalyst ink (34) to the polymer electrolyte membrane; and the drying device (26) configured to heat and dry the catalyst ink applied to the polymer electrolyte membrane, wherein the drying device is disposed rearward of the applying device in the direction of relative movement of the applying device relative to the polymer electrolyte membrane.

According to the above configuration, the catalyst ink can be applied in a state where the polymer electrolyte membrane is swollen, and therefore, the occurrence of wrinkles in the membrane electrode assembly and the occurrence of thin portions in the catalyst layer are suppressed.

Although the present disclosure has been described in detail, the present disclosure is not limited to the above-described embodiments. In these embodiments, various addition, replacement, changing, partial deletion, and the like can be made without departing from the essence and gist of the present disclosure or without departing from the essence and gist of the present disclosure derived from the contents described in the claims and equivalents thereof. These embodiments may also be implemented in combination. For example, in the above-described embodiments, the order of operations and the order of processes are shown as examples, and the present invention is not limited to them. The same applies to a case where numerical values or mathematical equations are used in the description of the above-described embodiments.

1. A method for manufacturing a membrane electrode assembly, the method comprising:
applying a catalyst ink to a first surface of a polymer electrolyte membrane; and
drying the catalyst ink that has been applied,
wherein the applying is performed in a state where a second surface of the polymer electrolyte membrane opposite to the first surface is in contact with a swelling solvent that swells the polymer electrolyte membrane.

2. The method for manufacturing the membrane electrode assembly according to claim 1, wherein
a boiling point of the swelling solvent is higher than a boiling point of an ink solvent contained in the catalyst ink.

3. The method for manufacturing the membrane electrode assembly according to claim 1, wherein the swelling solvent is heated water.

4. The method for manufacturing the membrane electrode assembly according to claim 1, wherein the swelling solvent is kept in a flowing state.

5. The method for manufacturing the membrane electrode assembly according to claim 1, further comprising
prior to the applying, disposing a metal mask on the first surface of the polymer electrolyte membrane,
wherein, in the applying, the catalyst ink is applied to the polymer electrolyte membrane through an opening of the metal mask.

6. The method for manufacturing the membrane electrode assembly according to claim 1, wherein
in the drying, the catalyst ink is dried by heating the catalyst ink in a state where the second surface of the polymer electrolyte membrane is in contact with the swelling solvent.

7. The method for manufacturing the membrane electrode assembly according to claim 1, wherein
the applying is performed using a manufacturing apparatus, the manufacturing apparatus including:
a solvent storage unit configured to store the swelling solvent;
a frame-shaped jig provided on the solvent storage unit, the frame-shaped jig being configured to bring the second surface of the polymer electrolyte membrane into contact with the swelling solvent while supporting a peripheral edge portion of the polymer electrolyte membrane; and
an applying device disposed above the polymer electrolyte membrane and configured to apply the catalyst ink to the polymer electrolyte membrane,
and wherein, prior to the applying,
the swelling solvent is supplied to the solvent storage unit; and
the polymer electrolyte membrane is supported on the frame-shaped jig and the second surface of the polymer electrolyte membrane is brought into contact with the swelling solvent.

8. The method for manufacturing the membrane electrode assembly according to claim 7, wherein
the manufacturing apparatus further includes a drying device configured to heat and dry the catalyst ink applied to the first surface of the polymer electrolyte membrane,
the drying device is disposed rearward of the applying device in a direction of relative movement of the applying device relative to the polymer electrolyte membrane, and
the drying is performed by relatively moving the drying device relative to the polymer electrolyte membrane so as to follow the applying device.

9. An apparatus for manufacturing a membrane electrode assembly, the apparatus comprising:
a solvent storage unit configured to store a swelling solvent;
a frame-shaped jig provided on the solvent storage unit, the frame-shaped jig being configured to bring a polymer electrolyte membrane into contact with the swelling solvent while supporting a peripheral edge portion of the polymer electrolyte membrane;
an applying device disposed above the polymer electrolyte membrane and configured to apply a catalyst ink to the polymer electrolyte membrane; and
a drying device configured to heat and dry the catalyst ink applied to the polymer electrolyte membrane,
wherein the drying device is disposed rearward of the applying device in a direction of relative movement of the applying device relative to the polymer electrolyte membrane.
